(19) United States
(12) Patent Application Publication
(10) Pub. No.: US 2004/0072554 A1
(43) Pub. Date: Apr. 15, 2004

(54) Automatic-bias amplifier circuit

(75) Inventors: Gregory N. Henderson, Sudbury, MA (US); Christopher C. Souchuns, Ashland, MA (US); Li Liu, Littleton, MA (US); Ping Li, Dunstable, MA (US); On San Andy Tang, Merrimack, NH (US); Ashley A. Imhoff, Boxford, MA (US)

Correspondence Address: BEVER HOFFMAN & HARMS, LLP, TRI-VALLEY OFFICE, 1432 CONCANNON BLVD., BLDG. G, LIVERMORE, CA, 94550, US

(73) Assignee: TriQuint Semiconductor, Inc.

(21) Appl. No.: 10/661,787

(22) Filed: Sep. 11, 2003

Related U.S. Application Data
(60) Provisional application No. 60/419,027, filed on Oct. 15, 2002.

(51) Int. Cl. H04B 1/16

(52) U.S. Cl. 455/341

(57) ABSTRACT

An automatic-bias amplifier circuit includes an amplifier having an input, an output, and a signal path between the input and output. A power detector is coupled for sampling the power of a signal passed on the signal path. The point of coupling may be the output and/or at one or more internal nodes of the amplifier. The power detector outputs an analog voltage signal reflective of the power of the signal to a bias circuit. The bias circuit causes the amplifier to draw a quiescent current, from a fixed level DC power supply, that varies in proportion to the analog voltage signal. Accordingly, the power consumption of the amplifier is optimized for all output power levels of the amplifier, while maintaining a desired degree of linearity. The automatic-bias amplifier circuit may be used in a wireless radio frequency communications device, e.g., a cellular phone.

### CROSS-REFERENCE TO RELATED APPLICATIONS

This application claims priority to U.S. Provisional Patent Application Serial No. 60/419,027, filed on Oct. 15, 2002, which is incorporated herein by reference in its entirety. This application also claims priority to U.S. patent application Ser. Nos. 10/459,239, entitled “Accurate Power Detection for a Multi-Stage Amplifier,” filed on Jun. 10, 2003 (Attorney Docket TRQ-12924), and 10/607,959, entitled “Continuous Bias Circuit and Method for an Amplifier,” filed on Jun. 27, 2003 (Attorney Docket No. TRQ-12905), both of which are incorporated herein by reference in their respective entireties.

### BACKGROUND OF THE INVENTION

1. Technical Field

The present disclosure relates to amplifiers, such as amplifiers that amplify radio frequency (RF) signals.

2. Discussion of the Related Art

Amplifiers are often used in portable, battery operated devices, such as cellular telephone and personal digital assistant (PDA) devices, to amplify RF signals. Performance of such an amplifier is largely judged by the amplifier's linearity and power efficiency. Linearity requires proportional amplification with low distortion over a wide dynamic range. Power efficiency requires low power consumption over the dynamic range. Typically, linearity is achieved at a cost to power efficiency, or vice versa.

For instance, in order to provide linearity over a wide dynamic range, it is conventional to bias the amplifier to operate most efficiently at a single output power level in the dynamic range. Typically, the selected single output power level is the level at which, statistically, the amplifier most commonly operates. This is effective for providing linearity over the dynamic range, but only provides power efficiency at the single output power level.

An alternative approach to improve power efficiency, while maintaining linearity, is to provide multiple amplifier stages and to combine their outputs. Such an approach allows a designer to separately optimize the power efficiency of each of the multiple amplifier stages. While this approach constitutes an improvement over biasing for a single output power level, efficiency is still improved at only a small number of the possible output power levels.

Therefore, a need exists to improve the power efficiency of an amplifier while still maintaining linearity over a wide dynamic range of operation.

### SUMMARY OF THE DISCLOSURE

The present invention includes a method and a circuit for operating and controlling an amplifier, so that the current consumption of the amplifier is automatically optimized over all output power levels, while maintaining a desired, high degree of linearity.

In one embodiment, an automatic-bias amplifier circuit includes an amplifier and a feedback loop coupled to the amplifier. A signal passes through the amplifier on a signal path, is amplified therein, and is output by the amplifier at a selected power level. The feedback loop includes a power detector coupled to the signal path for sampling the signal and a bias circuit coupled between the power detector and a bias input of the amplifier. The power detector may be coupled to the signal path for sampling at one or more points, e.g., at the amplifier output, or at one or more internal nodes of the amplifier. The power detector samples the signal on the signal path and outputs, to downstream elements of the feedback loop, an analog, i.e., continuously-varying, voltage signal reflective of the detected power of the signal. The bias circuit causes the amplifier to draw an analog quiescent current from a fixed-voltage level DC voltage source. The quiescent current varies proportionally with the analog voltage signal output by the power detector. Accordingly, the current consumption of the amplifier is self-optimized for the power of the signal being output by the amplifier.

The automatic-bias amplifier circuit may be part of a wireless communications device, such as a cellular phone or a personal digital assistant device. A baseband processor of the wireless communications device generates a data signal, which is converted to a RF signal and provided to a preamplifier on the signal path. The RF signal is amplified by the preamplifier, and is then provided to the automatic-bias amplifier. The baseband processor also continuously determines a desired power level of the signal to be output by the automatic-bias amplifier. The baseband processor continuously adjusts the gain of the preamplifier so that, at any given time, the RF signal provided to the automatic-bias amplifier circuit by the preamplifier will have a power level sufficient to allow the automatic-bias amplifier circuit to further amplify the RF signal to the desired power level. Meanwhile, the power detector of the automatic-bias amplifier circuit samples the RF signal on the signal path of the amplifier, and provides an analog voltage signal reflective of the power of the sampled RF signal to the feedback loop. The bias circuit of the feedback loop causes the automatic-bias amplifier to draw an analog quiescent current from a fixed-level DC voltage supply. The quiescent current varies proportionally with the analog voltage signal. The current consumption of the amplifier is thereby optimized for all output power levels specified by the baseband processor, while maintaining a desired degree of linearity.

These and other aspects of the present invention will become more apparent through consideration of the accompanying drawings and the following detailed description of the exemplary embodiments

### BRIEF DESCRIPTION OF THE DRAWINGS

FIG. 1 is a block diagram of an embodiment of a radio frequency transmission circuit that includes an automatic-bias amplifier circuit, in accordance with the present invention.

FIG. 2 is a block diagram of an embodiment of the automatic-bias amplifier circuit of FIG. 1.

FIG. 3 is a diagram of a conventional power detector that may be used in accordance with the present invention.

FIG. 4 is diagram of an alternative power detector that may be used in accordance with the present invention.

FIG. 5 is a schematic diagram of an embodiment of a linearizer circuit.

FIG. 6 is a schematic diagram of an embodiment of an amplifier bias circuit, in accordance with the present invention.

FIG. 7 is a graph of linearity versus output power of a simulated automatic-bias amplifier.

FIG. 8 is a graph of current consumption versus output power for a simulated automatic-bias amplifier.

In the present disclosure, like objects that appear in more than one figure are typically provided with like reference numerals.

### DETAILED DESCRIPTION

The present invention includes an automatic-bias amplifier circuit that includes an amplifier, and a feedback loop that automatically regulates the amplifier's current consumption.

The particular example discussed below relates to an automatic-bias amplifier circuit used to amplify RF signals in a wireless communications device, but practitioners will appreciate that the teachings herein may be used with respect to other amplifier applications.

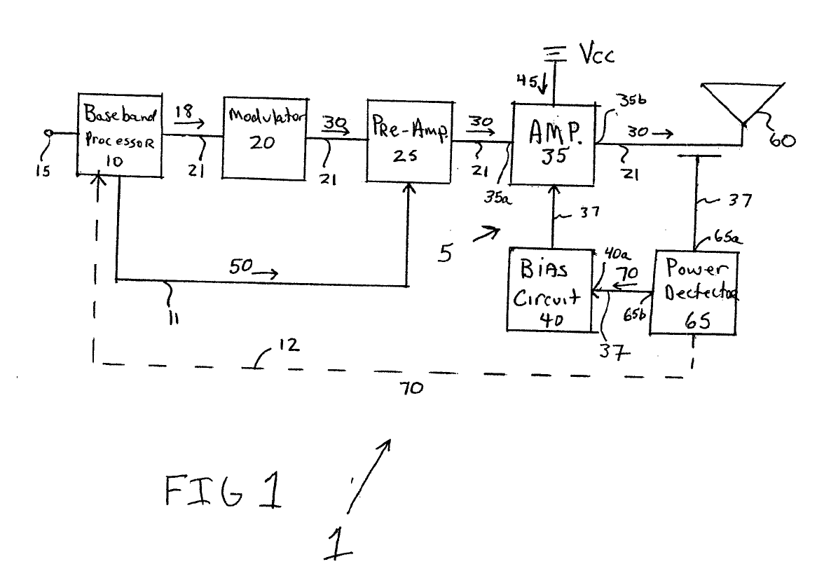

FIG. 1 is a simplified block diagram of an embodiment of a radio frequency transmission circuit 1 in accordance with the present invention. Included within radio frequency transmission circuit 1 is an automatic-bias amplifier circuit 5, which includes amplifier 35 and a feedback loop 37 that is disposed between a sampling point on a signal path 21, e.g., at the output 35b of amplifier 35, and a bias input of amplifier 35, as is discussed below. Feedback loop 37 includes a power detector 65 and a bias circuit 40. Bias circuit 40 is coupled to power detector 65 and ultimately receives the output of power detector 65.

As an example, radio frequency transmission circuit 1 may be in a battery-operated wireless communications device, e.g., a cellular telephone or PDA device, that transmits and receives RF signals. Radio frequency transmission circuit 1 may operate according to any number of communication standards, including, but not limited to, the CDMA, WCDMA, GSM, or AMPS standards.

Radio frequency transmission circuit 1 includes a baseband processor 10 that receives data, e.g., voice and/or packet data, at input 15. Based on this data input, baseband processor 10 outputs an encoded data signal 18 to a modulator 20. Modulator 20 modulates the data signal 18 to produce a RF signal 30. The RF signal 30 is provided to a preamplifier 25, which amplifies the RF signal 30 and provides the RF signal 30 to input 35a of amplifier 35. Amplifier 35 further amplifies the RF signal 30, and outputs the further-amplified RF signal 30 to antenna 60 via output 35b of amplifier 35. Amplifier 35 may be a single stage amplifier, or a multi-stage (i.e., two or more stages) amplifier. Antenna 60 broadcasts RF signal 30. Signal path 21, on which RF signal 30 passes, extends from the baseband processor 10 port that outputs data signal 18 though modulator 20, preamplifier 25 and amplifier 35 to antenna 60.

Baseband processor 10 also outputs an analog, i.e., continuously varying, voltage signal 50 that is provided to preamplifier 25 via line 11. Voltage signal 50 has a magnitude determined in real time by baseband processor 10 to achieve a desired power level in the RF signal 30 that is output by amplifier 35 and broadcast via antenna 60.

In a wireless communications embodiment, baseband processor 10 determines the magnitude of voltage signal 50 in real time by decoding an output power instruction that baseband processor 10 receives at its input 15 from an external source, such as a base station in RF communication with a mobile unit (e.g., a cellular phone) that includes radio frequency transmission circuit 1. The output power instruction is available in most systems that operate according to the WCDMA, CDMA, Global System for Mobile Communications (GSM), and the Advanced Mobile Phone Service (AMPS) standards.

At preamplifier 25, voltage signal 50 is used to adjust the gain of preamplifier 25 using any of several methods. For instance, voltage signal 50 may be input to a bias circuit that causes the pre-amplifier bias voltage to vary. The magnitude of voltage signal 50 is selected by baseband processor 10 so that preamplifier 25 will provide amplifier 35 with an input RF signal 30 having just the right amount of power for amplifier 35 to further amplify the RF signal 30 to the desired output power level, as was previously-determined by baseband processor 10, for broadcast via antenna 60.

Baseband processor 10 accounts for the characteristics of amplifier 35 in determining the value of analog voltage signal 50. In one embodiment, baseband processor 10 relies on a software model of amplifier 35, and determines the value of analog voltage signal 50 based on the model. For instance, the model includes the expected amount of amplification by amplifier 35.

In an alternative embodiment, shown by dash lines in FIG. 1, baseband processor 10 is coupled to power detector 65 by feedback line 12, and receives an analog voltage signal 70 from power detector 65 via feedback line 12. As discussed below, voltage signal 70 is reflective of the power the RF signal 30 at the point of sampling, e.g., at output 35b of amplifier 35. In this alternative embodiment, baseband processor 10 uses voltage signal 70 to determine the value of analog voltage signal 50 in real time. In other words, baseband processor 10 uses the sampled RF signal 30 to determine the value of analog voltage signal 50.

As mentioned, feedback loop 37 includes a power detector 65 that is coupled to signal path 21. In the embodiment of FIG. 1, input 65a of power detector 65 is coupled to signal path 21 at output 35b of amplifier 35, prior to antenna 60. However, as discussed below, power detector 65 alternatively may be coupled to signal path 21 at one or more internal nodes of amplifier 35, or both at the output 35b and at one or more internal nodes of amplifier 35. Power detector 65 can be coupled to the signal path 21 by a directional coupler or inductive coupling, or the like.

Power detector 65 samples the power of RF signal 30 on signal path 21, and provides at its output 65b an analog voltage signal 70 that reflects the detected power of RF signal 30. The analog voltage signal 70 is provided to downstream elements of feedback loop 37. In the embodiment of FIG. 1, bias circuit 40 receives the analog voltage signal 70 from output 65b of power detector 65, and uses voltage signal 70 to control the current consumption of amplifier 35. (Note that, while we say that bias circuit 40 receives and uses the analog voltage signal 70, this includes receiving and using either the actual analog voltage signal 70 output by power detector 65, or a signal derived therefrom, which may be, e.g., a shifted and/or linearized signal.)

In particular, bias circuit 40 controls an amount of an analog quiescent current 45 that amplifier 35 draws from a fixed-level DC voltage source Vcc based on the voltage of analog voltage signal 70. The quiescent current 45 continuously varies in proportion to the continuously-varying voltage of voltage signal 70. The value of quiescent current 45 is selected so that amplifier 35 will have an optimum current consumption for a selected linearity over the range of output power levels selected by baseband processor 10 for the RF signal 30 being output by amplifier 35 to antenna 60.

For example, in one implementation, as the input power of the RF signal 30 provided by preamplifier 25 to amplifier 35 increases (decreases) due to an increase (decrease) in the voltage of the analog voltage signal 50 provided to preamplifier 25 by baseband processor 10, the voltage of voltage signal 70 output by power detector 65 increases (decreases) because the power of the RF signal 30 output by preamplifier 25 and then amplifier 35 was increased (decreased). Based on the increased (decreased) voltage of voltage signal 70, bias circuit 40 proportionally increases (decreases) the quiescent current 45 provided to amplifier 35 from the fixed-level DC voltage source Vcc, thereby obtaining the optimum current consumption at the desired linearity (e.g., Adjacent Channel Power Ratio (ACPR) of −48 dBc or better) for the output power level of amplifier 35 selected by baseband processor 10. The quiescent current 45 sets the linearity. Increasing the quiescent current 45 provides more linearity, and vice versa.

Bias circuit 40 may be temperature compensated so that the value of quiescent current 45 will not appreciably vary with temperature.

Amplifier 35 may include only one amplifier stage, or two or more amplifier stages. In the case of a multi-stage amplifier, a single bias circuit 40 can control the quiescent current 45 to one or more of the stages of amplifier 35. Alternatively, a separate bias circuit 40 can be provided for each of the amplifier stages.

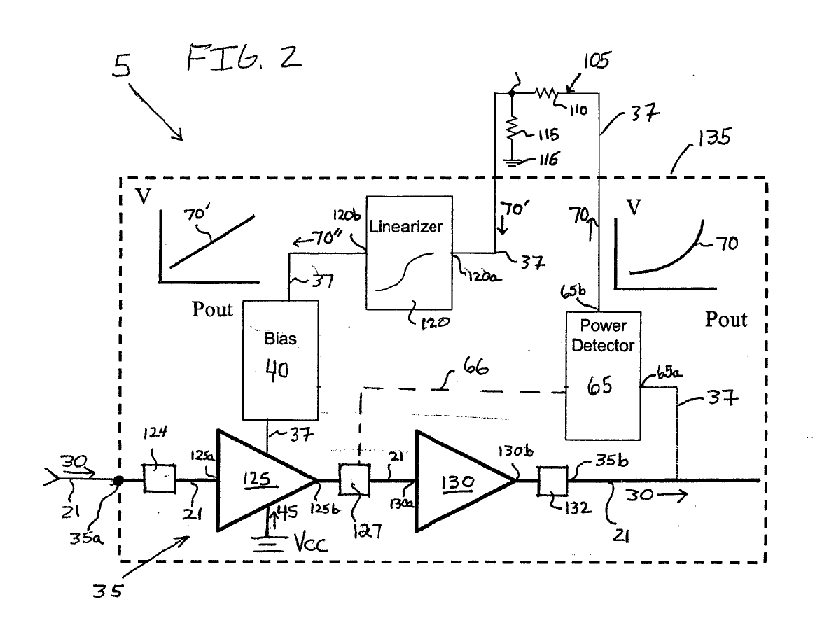

FIG. 2 is a block diagram of an embodiment of automatic-bias amplifier circuit 5 of FIG. 1. In this example, amplifier 35 includes a plurality of amplifier stages, i.e., a first amplifier stage 125 and a second amplifier stage 130, on signal path 21 between input 35a and output 35b of amplifier 35.

Referring to FIG. 2, amplifier 35 of FIG. 2 includes an input matching network 124 that receives RF signal 30 from preamplifier 25 via input 35a of amplifier 35. Input matching network 124 provides for proper matching of impedances between preamplifier 25 and first amplifier stage 125. First amplifier stage 125 includes an input 125a and an output 125b. An interstage matching network 127 is on signal path 21 between the output 125b of first amplifier stage 125 and an input 130a of second amplifier stage 130, and provides for impedance matching between the first and second amplifier stages 125, 130. An output 130b of second amplifier stage 130 is provided to output 35b of amplifier 35 through an output impendence matching network 132. Output matching network 132 provides for matching of impedances between second amplifier stage 130 and the antenna 60 (FIG. 1) that is coupled to output 35b of amplifier 35. Input matching network 124, interstage matching network 127, and output matching network 132 may include inductors, capacitors, resistors, and/or other components common to impedance matching networks.

In FIG. 2, power detector 65 is coupled to signal path 21 at output 35b of amplifier 35. Power detector 65 detects the power of RF signal 30 at the point of coupling to signal path 21, and generates the analog voltage signal 70. Analog voltage signal 70 is reflective of the power of RF signal 30 at the point of sampling. Power detector 65 may detect the power of RF signal 30 by measuring the RF voltage or the RF current.

Power detector 65 outputs analog voltage signal 70 to downstream elements of feedback loop 37, which in FIG. 2 include an optional voltage divider circuit 105, an optional linearizer circuit 120, and a bias circuit 40 that is coupled to one or more bias inputs of amplifier 35. Other embodiments may include more or fewer circuit elements within feedback loop 37.

Voltage divider 105 includes resistors 110 and 115. An input of resistor 110 is coupled to output 65b of power detector 65, and receives analog voltage signal 70. The output of resistor 110 is provided to node 117. Resistor 115 is coupled between node 117 and ground 116.

Voltage divider 105 divides the voltage of voltage signal 70 to a level suitable for use downstream. This has the effect of controlling the amount of quiescent current 45 drawn by amplifier 35, because the amount of quiescent current 45 varies proportionally with the voltage of analog voltage signal 70. Accordingly, the user of automatic-bias amplifier circuit 5, e.g., a cellular phone manufacturer, can tailor the current consumption and linearity of amplifier 35 by adjusting the resistance values of voltage divider 105.

In an alternative embodiment, voltage divider 105 may omitted. If necessary, the voltage division function may be incorporated in bias circuit 40.

In a further alternative embodiment, voltage divider 105 may be replaced by another circuit that shifts the voltage of voltage signal 70, either increasing or decreasing the voltage. For instance, an amplifier circuit could be used to increase the voltage of voltage signal 70, if the particular power detector 65 used did not output voltage signal 70 at a high enough level for downstream use.

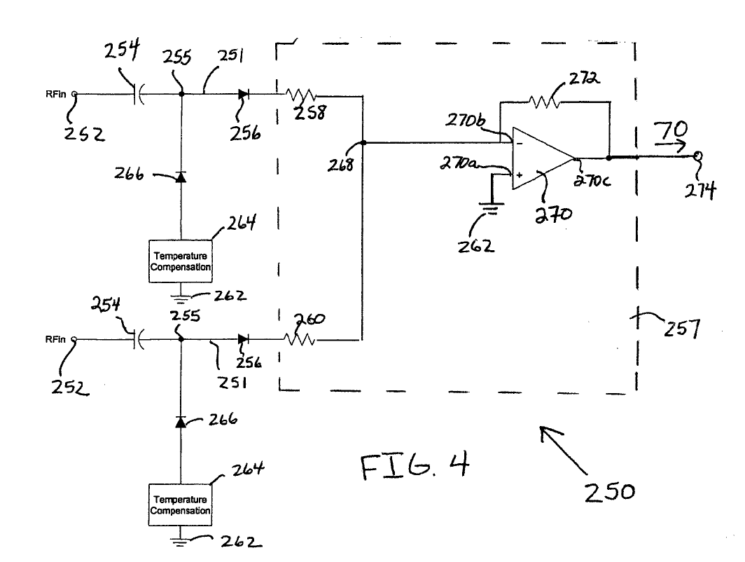

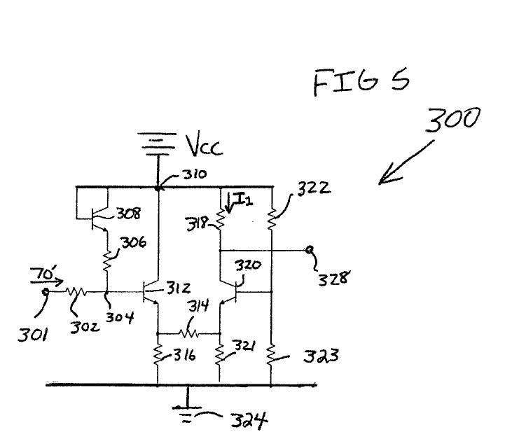

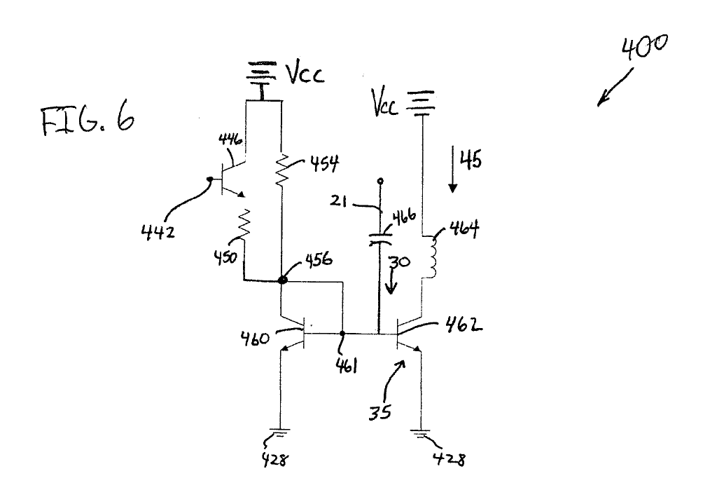

Voltage divider 105 of FIG. 2 is coupled to linearizer circuit 120 of feedback loop 37. Linearizer circuit 120 receives the divided analog voltage signal 70 at its input 120a from node 117 of voltage divider 105. Linearizer circuit 120 is utilized in a case where the particular power detector 65 used (see, e.g., FIG. 4) outputs a non-linear voltage signal 70, as depicted by the graph on the right side of FIG. 2, but the downstream bias circuit 40 (see, e.g., FIG. 6) is linear. Linearizer 120 linearizes analog voltage signal 70, and outputs a linearized analog voltage signal 70 that is approximately linear as a function of power, as depicted by the voltage signal 70 graph on the left side of FIG. 2.

Linearizer circuit 120 would not be necessary in a case where power detector 65 had a linear output. In other words, a linearizer circuit may or may not be necessary, depending on whether the power detector 65 and bias circuit 40 have matching characteristics.

The linearizer 120 is coupled to bias circuit 40, and provides the divided, linearized analog voltage signal 70 from its output 120b to bias circuit 40. Bias circuit 40 is coupled to a bias connection point of first amplifier stage 125 of amplifier 35. As discussed below, bias circuit 40 uses the linearized analog voltage signal 70 to control an amount of a variable quiescent current 45 that first amplification stage 125 of amplifier 35 draws from a fixed-level DC voltage source Vcc, thereby optimizing the current consumption of amplifier 35 for a selected linearity given the output power level previously selected by baseband processor 10 for the RF signal 30 output by amplifier 35.

In FIG. 2, most of automatic-bias amplifier circuit 5, including all parts of amplifier 35, bias circuit 40, power detector 65, and optional linearizer 120, are formed together on a single integrated circuit 135. However, voltage divider 105 of feedback loop 37 is external to the single integrated circuit 135. Such a configuration allows the user, such as a cellular phone manufacturer, to customize the voltage level of analog voltage signal 70, and hence the ultimate value of quiescent current 45, as mentioned above, by adjusting the resistance values or configuration of voltage divider 105. Preamplifier 25 may also be formed on the single integrated circuit 135.

In an alternative embodiment, all parts of automatic-bias amplifier circuit 5, including amplifier 35, bias circuit 40, power detector 65, linearizer 120, and voltage divider 105, are formed together on a single integrated circuit 135. Preamplifier 25 may also be formed on the single integrated circuit 135.

Integrated circuit 135 may be formed using silicon, silicon germanium, gallium arsenide, or other conventional process technologies.

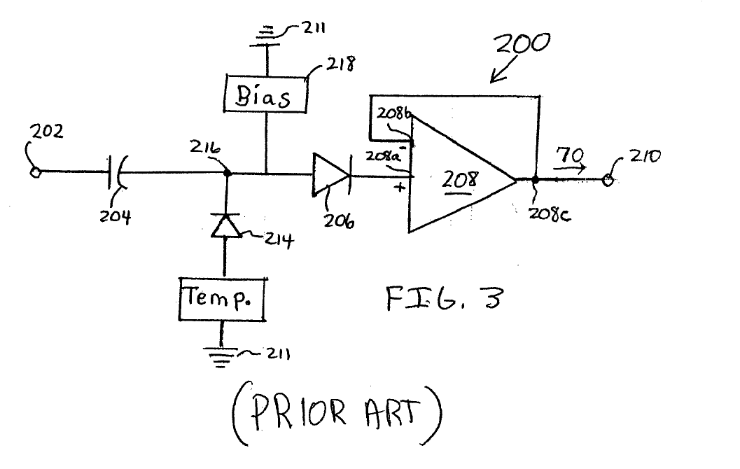

Numerous configurations are possible for power detector 65 of FIGS. 1 and 2. In FIG. 3, a block diagram of a conventional Schottky diode power detector 200 is depicted as an example of power detector 65 of FIGS. 1 and 2. An input 202 of power detector 200 is coupled to signal path 21 at the output 35b of amplifier 35 (FIGS. 1, 2), and inputs a sample of RF signal 30. A capacitor 204 is coupled to input 202, and provides for AC coupling. An output of capacitor 204 is provided to diode 206 via node 216. Diode 206 provides half-wave rectification. Between node 216 and ground 211 is a temperature compensation circuit 212 and a diode 214. Temperature compensation circuit 212 provides additional or reduced bias to the input signal in order to compensate for temperature. The output of diode 206 is coupled to a non-inverting input 208a of an operational amplifier 208. Bias circuit 218 also may be coupled to the non-inverting input 208a of operational amplifier 208. The inverting input 208b of operational amplifier 208 is coupled to its output 208c. Hence, operational amplifier 208 is in a follower configuration. The output 208c of operational amplifier 208 passes analog voltage signal 70 to output 210 of power detector 200.

An aspect of this exemplary embodiment of power detector 65 is that power detector 65 does not feed the modulation of RF signal 30 into the feedback loop 37, because the power detector 65 has a low frequency response, and thus only weakly tracks the signal envelope. This low frequency response may be achieved through filtering within operational amplifier 208.

The place where power detector 65 is coupled to signal path 21 of FIGS. 1 and 2 may vary. For instance, power detector 65 may be coupled for sampling RF signal 30 at an interior node of amplifier 35 on signal path 21, rather than being coupled to signal path 21 at the output 35b of amplifier 35. By interior node, we mean a node on the signal path 21 that is between, but exclusive of, the input 35a and the output 35b of the multi-stage amplifier 35. For instance, with respect to FIG. 2, power detector 65 may sample at interior nodes such as output 125b of first amplifier stage 125, input 130a of second amplifier stage 130, or output 130b of second amplifier stage 130 prior to output matching network 132, or within interstage matching network 127 or output matching network 132. As an example, FIG. 2 shows an alternative coupling of power detector 65 to signal path 21 at an interior node within interstage matching network 126 of amplifier 35 via line 66.

Coupling power detector 65 to an interior node of a multi-stage amplifier 35, e.g., within interstage matching network 127, may provide a more accurate determination of the power of the amplified RF signal 30 output by multi-stage amplifier 35. Specifically, impedance changes at the output 35b of amplifier 35 due to changes in the load impedance, e.g., when the antenna 60 (FIG. 1) is brought into contact with an object, may have a lesser effect on power detector 65 when power detector 65 is coupled to such an interior node. In selecting an interior node at which to sample, one may wish to select a node where there is a large voltage variation with power, but that is relatively insensitive to mismatch.

Of course, sampling RF signal 30 upstream of the output 35b of amplifier 35, e.g., at an interior node of amplifier 35, or even at input 35a, requires that some accounting be made for amplifier characteristics downstream of the point of sampling, such as in the system calibration, or using stored values in memory, software, and/or firmware.

In an alternative embodiment, power detector 65 is coupled for sampling at a plurality points on signal path 21 of FIGS. 1 and 2. For instance, power detector 65 may be coupled for sampling at output 35b and one or more interior nodes of amplifier 35. Alternatively, power detector 65 may be coupled for sampling at a plurality of interior nodes within amplifier 35, and not at output 35b. Alternatively, power detector 65 may be coupled to input 35a of amplifier 35 and to either an interior node within amplifier 35 or to output 35b of amplifier 35. In other words, the plural points on signal path 21 to which the power detector 65 may be coupled for sampling may vary.

In FIG. 4, a multiple node power detector 250 is shown, which may be used in the circuits of FIGS. 1 and 2 as power detector 65. For the sake of example, power detector 250 has two sample input lines 251, and thus can sample at RF signal 30 at two nodes on signal path 21 (FIGS. 1 and 2), but power detector 250 may be expanded to sample at three or more nodes by increasing the number of sample input lines 251.

Each of the two sample input lines 251 of power detector 250 includes an input 252 that is coupled for sampling to the signal path 21 (FIGS. 1, 2). An input of a capacitor 254 is coupled to input 252, and an output of a capacitor 254 is coupled to an input of a diode 256 through a node 255. Diode 256 provides half-wave rectification. The output of diode 256 is coupled to an input of a summing amplifier 257, as discussed below. Between ground 262 and node 255 is a temperature compensation circuit 264 and a diode 266. Temperature compensation circuit 264 provides additional or reduced bias to the input signal in order to compensate for temperature.

Summing amplifier 257 is coupled to the output of each of the diodes 256. Summing amplifier 267 includes resistors 258, 260, and 272, and an operational amplifier 270. Resistor 258 is coupled to receive the output of the diode 256 of one of the sample input lines 251 of power detector 250. Resistor 260 is coupled to receive the output of the diode 256 of the other sample input line 251 of power detector 250. The output of resistors 258, 260 is provided to the inverting input 270b of operational amplifier 270 via node 268. The non-inverting input 270a of operational amplifier 270 is coupled to ground 262. Resistor 272 is coupled between the output 270c of operational amplifier 270 and the inverting input 270b.

Summing amplifier 257 sums the respective signal outputs of the sample input lines 251 of power detector 250, and outputs a signal (e.g., a DC voltage) that reflects the power of RF signal 30 at the plural nodes being sampled. Sampling a plurality of nodes of amplifier 35, and summing the detected voltages can potentially provide more accurate power detection.

The ratio of the values of resistors 258 and 260 determines the weight that will be accorded to the outputs of the two sampling input lines 251 of power detector 250. For instance, if the resistances are equal, then equal weight is accorded to the two nodes being sampled by power detector 250. On the other hand, if resistor 260 has a greater resistance than resistor 258, then greater weight would be given to the sample passed through the sample input line 251 that includes resistor 260. Such an unequal weighting may be desirable where one sampling node provides relatively more useful data.

While a particular summing amplifier 257 is provided in the exemplary circuit of FIG. 4, any other known circuits capable of summing the outputs of the plural sample input lines 251 may be used. In addition, instead of using a summing circuit, other circuits may be coupled to the output of the sample input lines 251, to create a different type of voltage signal 70 reflective of the power of RF signal 30. For instance, a differential signal may be produced. That is, in place of summing amplifier 257, a differential amplifier may be used that determines a difference between the signal outputs of the respective sample input lines 251, and outputs a differential signal that reflects the power of the RF signal 30 at the plural nodes being sampled.

FIG. 5 is a schematic diagram of an embodiment of a linearizer circuit 300 that may be used as linearizer 120 of FIG. 1. Linearizer circuit 300 receives the divided analog voltage signal 70 (FIGS. 1, 2) at its input 301 from node 117 of voltage divider 105 (FIG. 2), and provides a voltage signal at its output 328 that varies proportionally with analog voltage signal 70 and is approximately linear as a function of the output power of the amplifier. True? In this embodiment, linearizer circuit 300 includes a differential amplifier built around NPN transistors 312 and 320.

In linearizer circuit 300, DC bias is provided to the base of transistor 312 through a NPN transistor 308 and resistor 306. Transistor 308 has its base and collector coupled to DC power supply Vcc through node 310. Accordingly, transistor 308 functions as a diode. Resistor 306 is coupled between the emitter of transistor 308 and the base of transistor 312. The collector of transistor 312 is coupled to power supply Vcc through node 310. Transistor 320 has its base coupled to power supply Vcc through resistor 322, and to ground 324 through resistor 323. The collector of transistor 320 is coupled to output 328, and to power supply Vcc through resistor 318. The emitters of transistors 312 and 320 are coupled to ground 324 through resistors 316 and 321, respectively, and are coupled together through resistor 314.

In linearizer circuit 300, resistors 316 and 321 define the amount of current that passes through the differential amplifier. In an alternative embodiment, resistors 316 and 321 could be replaced by current sources. Resistor 314 sets the degree of linearity of the differential amplifier. Resistors 322 and 323 set a threshold voltage of the differential amplifier by setting the DC bias at the base of transistor 320.

In operation, voltage signal 70 passes to the base of transistor 312 via resistor 302 and node 304. The differential amplifier formed by transistors 312 and 320 amplifies a difference between the voltages at the bases of transistors 312 and 320. The DC bias at the base of transistor 320 is fixed, and the voltage at the base of transistor 312 is compared to this voltage. If, for the sake of example, analog voltage signal 70 was zero, all current in the differential amplifier would pass through transistor 320, resulting in a relatively large voltage drop across resistor 318 and a relatively low base level voltage at output 328. As the voltage at the base of transistor 312 passes the voltage at the base of transistor 320 due to the voltage of analog voltage signal 30, the current in the differential amplifier is shifted from transistor 320 to transistor 312. This reduces the current I, through resistor 318, and thus increases the voltage of the voltage signal at output 328 beyond the base level mentioned above. As mentioned, the voltage signal at output 328 varies proportionally with the voltage of analog voltage signal 70 and is can be made to be an approximately linear function of the power of RF signal 30 through proper choice of the resistors 314, 316, and 321.

By adjusting the value of the resistors 314, 316, and 321, the quiescent current 45 (FIG. 6) can be adjusted to match the optimal value as a function of the detected voltage signal 70. If it is necessary that the quiescent current 45 ramp faster with output power, the value of resistor 314 can be reduced, and visa versa. The absolute value of the current I₁, and hence of quiescent current 45, can be adjusted by adjusting the value of resistors 316 and 321. By adjusting the magnitude of current I₁ and the value of resistor 318, the target voltage can be provided via output 328 to the downstream bias circuit of feedback loop 37, as is discussed below.

FIG. 6 is a schematic diagram of an exemplary bias circuit 400, which may be used as bias circuit 40 of FIG. 1. Input 442 of bias circuit 400 is coupled to receive the linearized voltage signal provided at output 328 of linearizer circuit 300 of FIG. 5. Input 442 is coupled to the base of an NPN transistor 446 of bias circuit 400. The collector of NPN transistor 446 is coupled to the fixed-level DC voltage source Vcc. A resistor 450 is coupled between the emitter of transistor 446 and a node 456. Transistor 446 is in an emitter follower configuration. Resistor 454 is coupled between voltage source Vcc and node 456.

An NPN transistor 460 has its collector and base coupled to node 456 and its emitter coupled to ground 428. A base of an NPN transistor 462 also is coupled to node 456. NPN transistor 462 has its emitter coupled to ground 428, and its collector coupled to the fixed-level DC voltage source Vcc through an inductor 464. The emitters of transistors 460, 462 are coupled to ground 428. NPN transistors 460 and 462 form a current mirror. NPN transistor 462 and inductor 464 are part of amplifier 35 of FIGS. 1 and 2, e.g., transistor 462 may be part of first amplifier stage 125 of FIG. 2.

Thus, bias circuit 400 and amplifier 35 are coupled at node 461 within the current mirror formed by transistor 460 of bias circuit 40 and transistor 462 of amplifier 35. Bias circuit 400 provides a bias input to amplifier 35 at the base of transistor 462. RF signal 30 also is provided to the base of transistor 462 via a coupling capacitor 466 of signal path 21.

In this exemplary embodiment, transistors 460 and 462 do not have a unity current mirror ratio, but rather have a current mirror ratio set so that much more current passes through transistor 462 than through transistor 460. For instance, transistors 460 and 462 may have a current mirror ratio of between about 1:60 and 1:80. Such a ratio is obtained by varying the size of the emitter junctions of transistors 460 and 462.

In operation, the bias circuit 400 of FIG. 6 receives the linearized analog voltage provided at output 328 of linearizer circuit 300. The resulting voltage at node 442 causes transistor 446 to pass a current from Vcc through resistor 450. The current through resistor 450 continuously varies in proportion to the continuously-varying voltage of voltage signal 70. A fixed-level current also is drawn from voltage source Vcc through resistor 454. The current through resistors 450 and 454 flows through transistor 460 via node 456.

Hence, the bias circuit 400 generates a current through transistor 460 that has two components: (1) an analog, i.e., continuously-varying, current portion drawn from power supply Vcc through transistor 446 and resistor 450 that varies proportionally with analog voltage signal 70; and (2) a constant current portion drawn from power supply Vcc through resistor 454. In an alternative embodiment, the constant current portion may be omitted by omitting resistor 454.

As mentioned, transistor 460 forms a current mirror with transistor 462, which is part of amplifier 35 of FIG. 1. The current through transistor 460 is mirrored through transistor 462 of amplifier 35. However, because the current mirror ratio of transistors 460 and 462 is about 1:60 to 1:80, transistor 462 draws a much larger quiescent current 45 from the fixed-level DC voltage source Vcc through inductor 464. Quiescent current 45 continuously varies proportionally with the continuously-varying voltage signal 70, but also includes a fixed component due to the constant-level current drawn through resistor 454. If analog voltage signal 70 was zero, or was below the threshold set by resistors 322 and 323 of linearizer circuit 300 of FIG. 5, then only the constant current drawn through resistor 454 would be mirrored into amplifier 35 as quiescent current 45.

Accordingly, automatic-bias amplifier circuit 5 of FIG. 1, as exemplified in FIGS. 2-6, is self-regulating, in that it automatically regulates in real time the amount of quiescent current 45 drawn from fixed-level supply Vcc by amplifier 35 over the full range of output powers of amplifier 35 specified by baseband processor 10. The magnitude of the quiescent current 45, and hence the linearity of amplifier 35, can be easily adjusted by adjusting the resistances of voltage divider 105, so that a desired balance of linearity and current consumption is obtained. In an embodiment where voltage divider 105 of feedback loop 37 is external to a single integrated circuit that includes all of amplifier 35 and the remainder of feedback loop 37, an adjustment of the magnitude of quiescent current 45 may be accomplished by the user, e.g., a cellular telephone manufacturer, by adjusting the resistance values of voltage divider 105.

Automatic-bias amplifier circuit 5 of FIG. 1 provides a convenience to users, e.g., cellular telephone manufacturers. Other means of regulating an amplifier in a cellular phone, such as the method described in co-pending application Ser. No. 10/607,959, cited above, use the voltage signal 50 output by baseband processor 10 to optimize the current consumption of the amplifier as a function of output power. In such embodiments, however, a change elsewhere in the system, e.g., such as a substitution of one baseband processor 10 for another or a change within baseband processor 10 could affect voltage signal 50, and thus might require a redesign and/or requalification of the amplifier bias circuit. With the embodiments described above, however, such a change would not require such a redesign or requalification effort, because automatic-bias amplifier circuit 5 self regulates its current consumption as a function of the output power of amplifier 35.

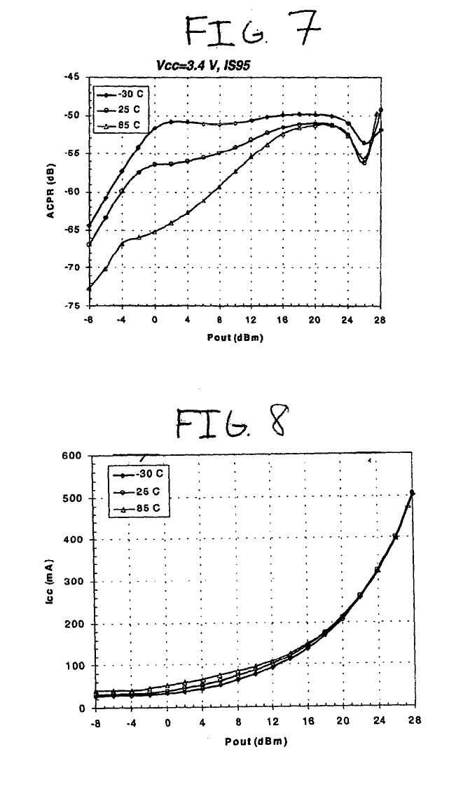

FIG. 7 is a graph of linearity, expressed in terms of ACPR, verses output power for a simulated automatic-bias amplifier circuit at three temperatures: −30° C., 25° C., and 85° C. In this example, the power supply voltage Vcc is 3.4 V. The IS-95 modulation format is used to make the measurements. The design was optimized for CDMA applications. Here, the analog voltage signal was varied as the input power to the amplifier was varied in order to keep the ACPR less than −48 dBc. In this way, no extra quiescent current is used at each output power, and the current consumption is optimized for each output power.

FIG. 8 is a graph of current consumption verses output power for a simulated automatic-bias amplifier circuit at three temperatures: −30° C., 25° C., and 85° C. The analog voltage signal was varied to keep the ACPR less than −48 dBc while minimizing the current consumption. FIG. 8 shows that, while output power is increased, current consumption, and therefore power consumption, is increased only minimally through the complete dynamic range. At low power in a standard amplifier with a fixed bias, the current consumption would be much higher with excess linearity. Note that the current has a non-zero floor value, as discussed above, due to a constant-level component.

As used herein, the terms “connected,” “coupled,” or variants thereof, mean any connection or coupling, either direct or indirect, between elements, unless further specified. Further, an element may be “between” two other elements regardless of whether other elements also are between the two elements.

The detailed description provided above is merely illustrative, and is not intended to be limiting. While the embodiments, applications and features of the present inventions have been depicted and described, there are many more embodiments, applications and features possible without deviating from the spirit of the inventive concepts described and depicted herein.

What is claimed is:

1. An automatic-bias amplifier circuit comprising:
an amplifier comprising an input, an output, and a signal path between and including the input and output of the amplifier, wherein the amplifier is coupled to a fixed-level DC voltage source; and
a feedback loop coupled between the signal path and a bias input of the amplifier, wherein the feedback loop comprises a power detector and a bias circuit,
wherein the power detector comprises an input coupled to the signal path, and is operable for sampling a first signal on the signal path and for outputting to the feedback loop an analog voltage signal reflective of the power of the first signal, and
wherein the bias circuit is on the feedback loop between the power detector and the bias input of the amplifier, and causes the amplifier to draw a quiescent current, from the fixed-level DC voltage source, that varies proportionally with the analog voltage signal.

2. The automatic-bias amplifier circuit of claim 1, wherein the power detector is coupled to the signal path at an internal node of the amplifier, said internal node being between, but exclusive of, the input and the output of the amplifier.

3. The automatic-bias amplifier circuit of claim 1, wherein the power detector is coupled to the signal path for sampling at a plurality of nodes of the amplifier.

4. The automatic-bias amplifier circuit of claim 3, wherein at least one of the plurality of nodes of the signal path to which the power detector is coupled is an internal node of the amplifier, said internal node being between, but exclusive of, the input and output of the amplifier.

5. The automatic-bias amplifier circuit of claim 1, wherein the power detector is coupled to the output of the amplifier.

6. The automatic-bias amplifier circuit of claim 1, wherein the amplifier comprises a plurality of amplifier stages and the power detector is coupled for sampling between a pair of the amplifier stages.

7. The automatic-bias amplifier circuit of claim 1, further comprising a voltage divider in the feedback loop between the power detector and the bias circuit, wherein a voltage of the analog voltage signal is divided by the voltage divider.

8. The automatic-bias circuit of claim 7, wherein the amplifier, the bias circuit, and the power detector are together on a single integrated circuit, and at least part of the voltage divider is external to the single integrated circuit.

9. The automatic-bias amplifier circuit of claim 1, further comprising a means in the feedback loop between the power detector and the bias circuit for shifting the voltage of the analog voltage signal.

10. The automatic-bias circuit of claim 1, wherein the amplifier, the bias circuit, and the power detector are together on a single integrated circuit, and at least part of the means for shifting the voltage of the analog voltage signal is external to the single integrated circuit.

11. The automatic-bias circuit of claim 1, further comprising a linearizer circuit in the feedback loop between the power detector and the bias circuit, wherein the analog voltage signal is linearized by the linearizer circuit.

12. The automatic-bias circuit of claim 1, wherein the bias circuit comprises a current mirror.

13. The automatic-bias circuit of claim 1, wherein the bias input is within a current mirror.

14. The circuit of claim 1, wherein the quiescent current includes a fixed-level portion and a continuously-varying portion.

15. The circuit of claim 1, wherein a transistor of the bias circuit is in a current mirror with a transistor of the amplifier, the current mirror having a non-unity current mirror ratio.

16. An automatic-bias amplifier circuit comprising:
an amplifier comprising an input, an output, and a signal path between and including the input and output of the amplifier;
a power detector comprising an input coupled to the signal path, said power detector being operable for sampling a first signal on the signal path and for outputting an analog voltage signal reflective of the power of the first signal; and
a bias circuit coupled between the amplifier and the power detector, wherein the bias circuit generates an analog current that varies proportionally with analog voltage signal, and mirrors the analog current into the amplifier as at least part of a quiescent current of the amplifier.

17. The automatic-bias amplifier circuit of claim 16, further comprising a voltage divider coupled between the power detector and the bias circuit, wherein the amplifier, the bias circuit, and the power detector are together on a single integrated circuit, and at least part of the voltage divider is external to the single integrated circuit.

18. The automatic-bias amplifier circuit of claim 16, further comprising a linearizer circuit coupled between the power detector and the bias circuit, wherein the linearizer circuit linearizes the analog voltage signal.

19. The automatic-bias circuit of claim 16, wherein the bias circuit also mirrors a fixed-level current into the amplifier, whereby the quiescent current of the amplifier includes a first portion based on the analog current and a second portion based on the fixed-level current.

20. A wireless communication device comprising:
a baseband processor, an antenna, and a signal path between the baseband processor and the antenna;
an amplifier comprising an input on the signal path, and an output on the signal path coupled to the antenna;
a fixed-level DC voltage source coupled to the amplifier;
a power detector operable for sampling an RF signal on the signal path and for outputting an analog voltage signal reflective of the power of the RF signal; and
a bias circuit coupled between the power detector and a bias input of the amplifier, wherein the bias circuit causes the amplifier to draw a quiescent current, from the fixed-level DC voltage source, that varies proportionally with the analog voltage signal.

21. The wireless communication device of claim 20, wherein the power detector is coupled for sampling at an internal node of the amplifier, said internal node being on the signal path between, but exclusive of, the input and the output of the amplifier.

22. The wireless communication device of claim 21, wherein the amplifier comprises a plurality of amplifier stages, and the power detector is coupled for sampling between a pair of the amplifier stages.

23. The wireless communication device of claim 20, further comprising a preamplifier on the signal path between the baseband processor and the input of the amplifier, wherein the baseband processor provides a continuously varying voltage signal to the preamplifier to vary a gain of the preamplifier.

24. The wireless communications device of claim 23, wherein the baseband processor generates the continuously varying voltage signal provided to the preamplifier based on the analog voltage signal.

25. The wireless communication device of claim 21, wherein the bias circuit generates an analog current that varies proportionally to the analog voltage signal, and mirrors the analog current into the amplifier as at least part of the quiescent current.

26. The wireless communication device of claim 25, wherein the bias circuit also mirrors a fixed-level current into the amplifier, whereby the quiescent current of the amplifier includes a first portion derived from the analog current and a second portion derived from the fixed-level current.

27. A wireless communication device comprising:
a baseband processor, an antenna, and a signal path between the baseband processor and the antenna;
an amplifier comprising an input on the signal path, and an output on the signal path coupled to the antenna;
a power detector operable for sampling an RF signal on the signal path and for outputting an analog voltage signal reflective of the power of the RF signal; and
a bias circuit coupled between the power detector and a bias input of the amplifier, wherein the bias circuit controls a quiescent current of the amplifier based on the analog voltage signal.

28. A method comprising:
providing an amplifier on a signal path, said amplifier having an input on the signal path and an output on the signal path;
receiving a first signal on the signal path at the input of the amplifier, amplifying the first signal in the amplifier, and outputting the amplified first signal at the output of the amplifier;
detecting a power level of the first signal on the signal path at a sampling point of the amplifier selected from a group consisting of the output of the amplifier and an interior node of the amplifier, said interior node being between, but exclusive of, the input and the output of the amplifier;
generating an analog voltage signal reflective of the detected power level of the first signal; and
drawing a quiescent current in the amplifier from a fixed level DC power supply, said quiescent current varying proportionally with the analog voltage signal.

29. The method of claim 28, wherein the power level of the first signal is detected at least at one said interior node.

30. The method of claim 29, wherein the amplifier includes a plurality of amplifier stages on the signal path, and the power level of the first signal is detected at a said interior node between a pair of the amplifier stages.

31. The method of claim 28, wherein a preamplifier is on the signal path prior to the input of the amplifier, and further comprising:
determining a desired power level of the amplified first signal to be output by the amplifier;
adjusting a gain of the preamplifier so that the first signal received at the input of the amplifier will have a magnitude sufficient to be amplified by the amplifier to the desired power level.

32. The method of claim 31, wherein the gain of the preamplifier is adjusted based on the analog voltage signal.

33. The method of claim 28, wherein the method includes converting the analog voltage signal to an analog current that varies proportionally with the analog voltage signal, and mirroring the analog current into the amplifier as at least part of the quiescent current.

34. The method of claim 28, wherein the method includes drawing a fixed level current from the fixed-level DC power supply, and mirroring the fixed-level current into the amplifier, whereby the quiescent current of the amplifier includes a first portion based on the analog current and a second portion based on the fixed-level current.

35. The method of claim 28, wherein the first signal is an RF signal, and detecting the power level of the first signal comprises measuring an RF voltage.

36. The method of claim 28, wherein the first signal is an RF signal, and detecting the power level of the first signal comprises measuring an RF current.
